(19) United States
(12) Patent Application Publication
(10) Pub. No.: US 2026/0082467 A1
(43) Pub. Date: Mar. 19, 2026

(54) IMPROVEMENTS OF HIGH FREQUENCY PFC CONVERTERS

(71) Applicant: SIGNIFY HOLDING B.V., EINDHOVEN (NL)

(72) Inventors: REINHOLD ELFERICH, AACHEN (DE); CHRISTIAN HATTRUP, WURSELEN (DE)

(21) Appl. No.: 19/110,874

(22) PCT Filed: Sep. 5, 2023
(86) PCT No.: PCT/EP2023/074251

§ 371 Date: Mar. 12, 2025

(30) Foreign Application Priority Data
Sep. 15, 2022 (EP) 22195965.3

(51) Int. Cl. H05B 45/355; H05B 45/375; H05B 45/38

(52) U.S. Cl. CPC H05B 45/355; H05B 45/375; H05B 45/38

(57) ABSTRACT

The invention relates to a driver for driving a load, the driver comprising a first node adapted to be coupled to a fluctuating voltage, a second node adapted to be coupled to a stable voltage, a switched mode power converter configured to convert the fluctuating voltage into the stable voltage or to convert the stable voltage into the fluctuating voltage, a first ceramic capacitor coupled to the first node, a second ceramic capacitor coupled between the first node and the second node.

### FIELD OF THE INVENTION

The invention relates to a driver. The invention further relates to a luminaire comprising the driver.

### BACKGROUND OF THE INVENTION

Drivers having switched mode power converters are used in many applications for electronics that require to be powered. Laptops, mobile phones and lighting applications all require a power supply that allows a regulated power to be provided while also preventing or minimizing the electric noise, electromagnetic interference, EMI, to be emitted to the grid. Capacitors are commonly used to provide a high frequency filtering of the EMI. For this function, the capacitor is normally a ceramic or a film capacitor as these types of capacitors are well suited for filtering high frequency components form a voltage. Ceramic capacitors come in many variants varying from low quality X5R type to X7R type, i.e. class 2 ceramic capacitors, to even NPO type, i.e. class 1 ceramic capacitors, of capacitors. NPO capacitors are considered to be technically the most interesting capacitors since they provide low tolerance capacitance values and the capacitance value is least sensitive to the voltage applied to the capacitor. NPO capacitors are however very expensive and also are limited in the sense of the capacitance. A small capacitance drop occurs when the voltage across the capacitor is large. If a larger capacitance value is needed, multiple NPO capacitors are needed, which add significantly to the cost and size of the power supply. X5R capacitors have high tolerances in the capacitance value and are also very sensitive to the voltage applied to the capacitor. A large capacitance drop occurs when the voltage across the capacitor is large. Therefore, to provide a large total capacitance at the multilayer ceramic capacitor, MLCC, rated voltage, a lot of capacitors need to be used.

FIG. 1 shows an example of the relationship of the capacitance value of a capacitor against the voltage across the capacitor. On the X-axis, the voltage across the capacitor is defined from 0 V to a maximum voltage vCmax that will be applied across the capacitor. On the Y-axis, the relative capacitance of the capacitor is defined. C defines the actual capacitance and C0 defines the absolute capacitance of the capacitor. The maximum relative capacitance is 1, where C is equal to C0. The minimum capacitance is the capacitance value Cmin. The relative minimum capacitance is therefore defined as Cmin/0O. Cmin/C0 is defined at the maximum voltage vCmax. Preferably, the voltage across the capacitor may not exceed this voltage. The capacitance of the capacitor is highest at the lowest voltage. An increasing voltage across the capacitor significantly, almost exponentially, lowers the capacitance. At higher voltages, the filter function, due to a lower capacitance value, is severely reduced. Therefore, to provide a good filter function also at higher voltages, the capacitor needs to be dimensioned such that at the highest voltage, the capacitance is still high enough. This results in an over dimensioning of the capacitor resulting in a capacitor that is higher in volume and/or cost. It is desired to provide a driver where the total capacitance of the capacitor can be used better without having to provide capacitors that are more expensive or larger in volume.

### SUMMARY OF THE INVENTION

It is an objective of the invention to provide a driver that has an improved utilization of the capacitances. This means that it is desired to use the same amount of capacitors as used in a conventional solution e.g. place two capacitors in parallel to double the effective capacitance but achieve a higher effective capacitance, especially at increasing voltages across the capacitors.

In a first aspect of the invention, a driver for driving a load is provided, the driver comprising:
a first node adapted to be coupled to a fluctuating voltage;
a second node adapted to be coupled to a stable voltage;
a switched mode power converter configured to convert the fluctuating voltage into the stable voltage or to convert the stable voltage into the fluctuating voltage;
a first ceramic capacitor coupled to the first node;
a second ceramic capacitor coupled between the first node and the second node, wherein the second ceramic capacitor is arranged to provide a dominant capacitance between the first node and the second node and the first ceramic capacitor is arranged to provide a dominant capacitance to the first node.

The driver has a switched mode power converter that is arranged to convert a fluctuating voltage into a stable voltage. This stable voltage may be provided to the load. The load may be any kind of load that requires a stable voltage. The load may also be another switched mode power converter that uses the stable voltage to convert into another voltage for another load. The operation of the switched mode power converter causes EMI, or noise, that needs to be filtered out. To reduce the noise from the switched mode power converter to the input, e.g. a mains voltage connection, capacitors are used. It is commonly known that capacitors are used for filtering out high frequency noise. The first ceramic capacitor is coupled to the first node. On this first node, the input voltage is received. The input voltage is a fluctuating voltage. This may be mains voltage, which is rectified. The rectified mains voltage is still fluctuating. The first ceramic capacitor is therefore used to provide a filtering function at the first node. The second ceramic capacitor is coupled between the first node and the second node. The second ceramic capacitor therefore provides a filtering function at the first node and to the second node. The voltage at the second node is a stable voltage, that is generated by the switched mode power converter. As a stable voltage, a voltage may be understood that has a steady DC voltage value with a superimposed ripple as a result of the operation of the switched mode power converter. The second ceramic capacitor is therefore placed between a stable voltage at one end and a fluctuating voltage at another end. The second ceramic capacitor is arranged to provide a dominant capacitance between the first node and the second node. The first ceramic capacitor is arranged to provide a dominant capacitance to the first node. This means that any other capacitor, e.g. such as an electrolytic capacitor, does not provide any significant capacitance at these nodes. The capacitance of these other capacitances at these nodes, e.g. in parallel to the first capacitor or second capacitor, is negligible on the capacitive behavior of the driver. The positioning of the two capacitors in this way allows the capacitors to provide an improved capacitance value at the input of the switched mode power converter over the entire range of the fluctuating voltage. The relation between the total capacitance value and the voltage across the two capacitors has been altered in a defined manner that increases the total capacitance, i.e. improved. If the fluctuating voltage is low, the capacitance of the first ceramic capacitor is high. The voltage across the second ceramic capacitor is then relatively large and therefore, the capacitance is lower. This will also be described in further detail in the detailed description of the embodiments. The total capacitance however is relatively large, i.e. the total capacitance remains larger than when the second ceramic capacitor would be placed in parallel with the first capacitance, especially at the higher voltage levels of the fluctuating voltage.

In a further example, a ratio between a capacitance of the first ceramic capacitor and a capacitance of the second ceramic capacitor is based on a ratio between a peak voltage of the fluctuating voltage and an amplitude of the stable voltage.

A ratio between the capacitances of the first ceramic capacitor and the second ceramic capacitor can be determined based on the ratio between a peak voltage of the fluctuating voltage and an amplitude of the stable voltage. This allows the optimized capacitance values to be used based on the type of switched mode power converter.

In a further example, the switched mode power converter is a boost converter wherein the first node is coupled to an input of the switched mode power converter and wherein the second node is coupled to an output of the switched mode power converter and the load.

In one example, the switched mode power converter is a boost converter. The first node is then used as an input for the switched mode power converter and is arranged to receive the fluctuating voltage, which may be mains or rectified mains. The second node is then used as the output of the switched mode power converter. The second ceramic capacitor is then coupled between the input and the output of the switched mode power converter.

In a further example, the switched mode power converter is a buck converter wherein the second node is coupled to an input of the switched mode power converter and wherein the first node is coupled to an output of the switched mode power converter and the load. A boost converter may be arranged to provide the stable voltage at the second node.

Instead of a boost converter, the switched mode power converter can also be a buck converter. The buck converter may receive a stable voltage. The second node is the input to the switched mode power converter. The first node is the output of the switched mode power converter. The voltage at the output of the switched mode power converter, i.e. the buck converter, may fluctuate. The fluctuation is provided to allow a change of power provided to the load. Increasing the voltage may result in an increase of power to the load and vice versa. The increase or decrease of the voltage is defined in the range of the output voltage of the driver. This is also referred to as the operating window of the driver. Such a driver may be called a window driver. The fluctuation may not be as large as the mains voltage fluctuation. The effect achieved with the first ceramic capacitor and the second ceramic capacitor may therefore be less, but will still provide an improvement over the conventional placement of capacitors, i.e. placing two capacitors in parallel.

In a further example, the driver comprises a third node adapted to be coupled to a further fluctuating voltage, wherein the switched mode power converter is a two stage converter, where a first stage is a boost converter and a second stage is a buck converter, wherein an output of the boost converter is coupled to an input of the buck converter, wherein the first node is coupled to an input of the boost converter, the second node is coupled to the output of the boost converter and the input of the buck converter and the third node is coupled to an output of the buck converter and the load, wherein the boost converter is adapted to provide the stable voltage to the second node and the buck converter is adapted to provide the further fluctuating voltage to the third node.

In a further example, the driver comprises a third capacitor coupled between the second node and the third node.

The driver can be a two-stage driver. A first stage of the driver is a boost converter, that converts a fluctuating voltage into a stable voltage. The second stage is a buck converter, that converts the stable voltage into a further fluctuating voltage. The definition of this fluctuating voltage may be the same as already defined for the buck converter. Since there are two stages, also some adaptations to the capacitor configurations are required. The first ceramic capacitor is coupled to the first node. The second ceramic capacitor is coupled between the first node and the second node. The second node is the output of the boost converter and the input of the buck converter. A third capacitor may be placed between the second node and the third node. The third node is the output of the buck converter. The two-stage driver receives a fluctuating voltage such as mains or rectified mains at the first node. The boost converter converts this fluctuating voltage into a stable voltage at the second node. The stable voltage is provided to the buck converter. The buck converter converts the stable voltage into a further fluctuating voltage and provides this at the third node. This fluctuating voltage is provided to the load. The fluctuating voltage is then used to provide a variable power to the load to e.g. provide dimming when the load is a lighting load. The two-stage driver allows both power factor correction to be performed and a good power regulation for the load.

In another example, a voltage fluctuation of the fluctuating voltage is larger than a voltage fluctuation of the further fluctuating voltage. Preferably, the fluctuating voltage may be a mains voltage and may have a voltage fluctuation of 0 V to e.g. 325 V. The voltage fluctuation of the further fluctuating voltage is significantly lower and may depend on the operating window of the driver. The operating window is defined as the voltage range that can be generated by the driver. This is then also the range of the further fluctuating voltage. The range may for example be a window between 40 V and 100 V. The desired effect of the invention is nevertheless achieved.

In a further example, the first ceramic capacitor and the second ceramic capacitor are multilayer ceramic capacitors, MLCC, capacitors.

Using MLCC capacitors, allows the use of capacitors that are very well suited for filtering out high frequency noise. Additionally, these types of capacitors have a large deviating capacitance value that strongly depends on and varies by the varying voltage across the capacitor.

In a further example, the first ceramic capacitor and the second ceramic capacitor are of the X7R type.

Using an X7R type provides a cost-effective solution. Using another material as NPO may be too expensive in applications, where with the invention, X7R becomes a suitable substitute. X5R material may be even cheaper but results in a very poor performance. In a further example, the switched mode power converter is arranged to provide power factor correction.

Preferably, the switched mode power converter can provide power factor correction. This improves the power factor of the driver. The mains voltage provided to the driver may be rectified and provided to the switched mode power converter. To provide a good power factor correction, the rectified mains voltage may not be buffered by e.g. an electrolytic capacitor. Therefore, the voltage fluctuation of the fluctuating voltage is as high as possible. The voltage across the first ceramic capacitor varies between 0 V and the peak voltage of the mains voltage.

In a further example, the switched mode power converter is a synchronous switched mode power converter.

A switched mode power converter being a synchronous switched mode power converter is more energy efficient. It further allows the switched mode power converter to use negative currents to be used to enable soft switching, resulting in lower EMI levels.

In a further example, the first ceramic capacitor and the second ceramic capacitor have a substantial identical capacitance.

Using the same type and/or value of the capacitor for the first ceramic capacitor and the second ceramic capacitor allows the same components to be used and therefore a cheaper driver to be made since one component with the double amount needed, results in a cheaper component piece price.

Alternatively, the first ceramic capacitor and the second ceramic capacitor have a substantial different capacitance from each other.

In a further example, the driver comprises a rectifier circuit adapted to rectify an alternating current, AC, voltage into a rectified voltage, wherein the rectified voltage is the fluctuating voltage.

Using a rectifier circuit for rectifying the AC voltage provides a DC voltage with a similar fluctuation, but rectified, as the AC voltage. This voltage can be used for effective power factor correction. The rectified voltage is then provided to the first node, causing the fluctuating voltage to be identical to the rectified voltage.

In another example, a system is provided. The system comprises the driver according to the invention and the load.

In another example, the load is a semiconductor lighting load and the system is a luminaire or a lamp.

Preferably, the load is a semiconductor lighting load such as an LED or a laser diode load. Preferably, the system is a luminaire or a lamp.

### BRIEF DESCRIPTION OF THE DRAWINGS

Examples of the invention will now be described with reference to the accompanying drawings, in which:

FIG. 1 shows an example of a relation between the voltage across a capacitor and the capacitance of the capacitor.

FIG. 2 shows an example of a circuit of a driver.

FIG. 3 shows an example of a relation between the voltage across a capacitor and the capacitance of the capacitor with an improved configuration.

FIG. 4 shows another example of a circuit of a driver.

FIG. 5 shows a further example of a circuit of a driver.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should also be understood that the Figures are merely schematic and are not drawn to scale. It should also be understood that the same reference numerals are used throughout the Figures to indicate the same or similar parts.

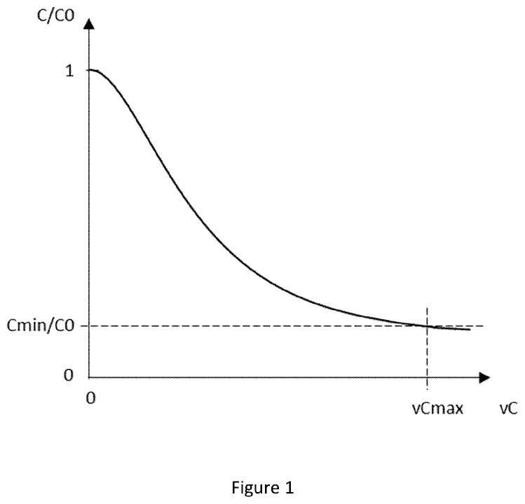

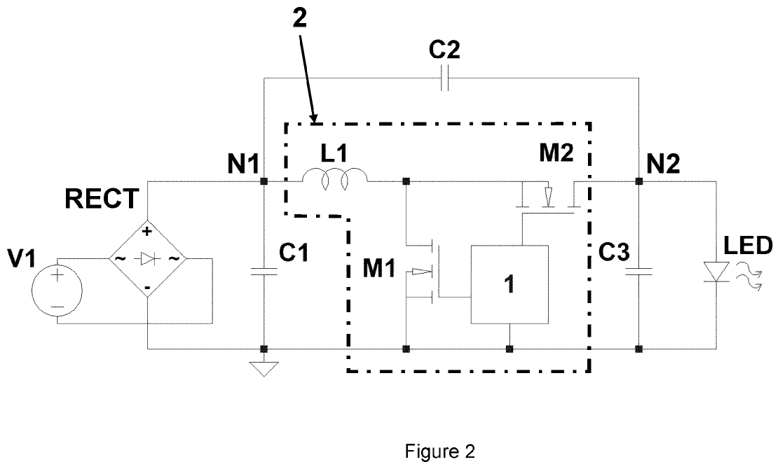

FIG. 2 shows an example of a driver. The driver has a switched mode power converter 2. In the example provided, the switched mode power converter 2 is a boost converter. A first node N1 is coupled to an input of the switched mode power converter 2. A second node N2 is coupled to an output of the switched mode power converter 2. The switched mode power converter 2 may have an inductor L1, a switch Mland another switch M2. A controller 1 is used to control the switch M1. The other switch M2 may be a diode. If the other switch M2 is a switch such as a transistor or MOSFET, the other switch may also be controlled by the controller 1. If the other switch M2 is a transistor or a MOSFET, the switched mode power converter 2 may be operated as a synchronous converter. A first ceramic capacitor C1 is, at one end, coupled to the first node N1. The other end of the first ceramic capacitor C1 is preferably coupled to a return path such as a ground reference. A second ceramic capacitor C2 is coupled between the first node N1 and the second node N2. The second ceramic capacitor C2 is arranged to provide a dominant capacitance between the first node N1 and the second node N2 and the first ceramic capacitor C1 is arranged to provide a dominant capacitance to the first node N1. A rectifier circuit RECT may be provided to rectify the input voltage V1. The input voltage may be any type of voltage, preferably a mains voltage as is commonly used such as 230 V at 50 Hz or 120 V at 60 Hz. An optional capacitor C3 may be used to buffer the output of the switched mode power converter 2 so that the voltage can be provided stabilized more reliably and easily. The optional capacitor C3 may be an electrolytic capacitor. The stable voltage is provided by the boost converter to the second node N2 and the load LED. The first ceramic capacitor C1 is exposed to the fluctuating voltage that is present at the first node N1. An example is now provided explaining the relationship of the voltages at the first node N1 and the second node N2 and the capacitance values of the first ceramic capacitor C1 and the second ceramic capacitor C2. If the fluctuating voltage is low, e.g. 0 V, the capacitance of the first ceramic capacitor C1 is largest, as can be seen from FIG. 1, where on the Y-axis, the point C/C0 is at 1. The stable voltage at the second node N2 is regulated to a steady voltage of e.g. 400 V. The differential voltage across the second ceramic capacitor C2 is 400 V, namely 400 V referred to 0 V. This means that the capacitance of the second ceramic capacitor C2 is at its lowest. This is shown in FIG. 1 where the value of C/C0 is at Cmin/C0. In this example, vCmax is 400 V. Now the fluctuating voltage increases. If the fluctuating voltage reaches e.g. 200 V, the voltage across the first ceramic capacitor C1 is 200 V. The voltage across the second ceramic capacitor C2 is 400V-200V=200V. In the examples provided, the polarity of the voltage across the capacitors is irrelevant for determining the capacitance value. The amplitude is considered to be the determining element of the voltage. The voltage across the first ceramic capacitor C1 and the second ceramic capacitor C2 are identical. This results in that the capacitances are also identical. The fluctuating voltage is increasing even further to the maximum voltage of e.g. 325 V. The voltage across the first ceramic capacitor C1 is 325 V. The voltage across the second ceramic capacitor C2 is 400V−325V=75V. The voltage across the first ceramic capacitor C1 is relatively large, resulting in a low capacitance value. The voltage across the second ceramic capacitor C2 is at a relatively low value, resulting in a relatively large capacitance value. The total capacitance that is available for filtering out noise generated by the switched mode power converter 2 is larger than when the capacitances C1 and C2 have been coupled in parallel at the first node N1. This means that with the same capacitors, a higher overall minimum capacitance is achieved, effectively improving the utilization of the capacitors.

Preferably, the first ceramic capacitor C1 is the only capacitor coupled at the first node N1. Preferably, the second ceramic capacitor C2 is the only capacitor coupled between the first node N1 and the second node N2. Preferably, the coupling of the first ceramic capacitor C1 is done between the first node N1 and the return path. By having only a ceramic capacitor, the total capacitance at the input of the driver is relatively low. This is mainly because the capacitance value of a ceramic capacitor is significant lower than the capacitance value of an electrolytic or film capacitor. Power factor correction can therefore be performed in an efficient way since the lower the input capacitance of a driver, the better the power factor can be corrected. This further allows the driver to operate at a high frequency because ceramic capacitors are very well suited for high frequency operation. Preferably, the driver may be operated at a frequency above 500 kHz.

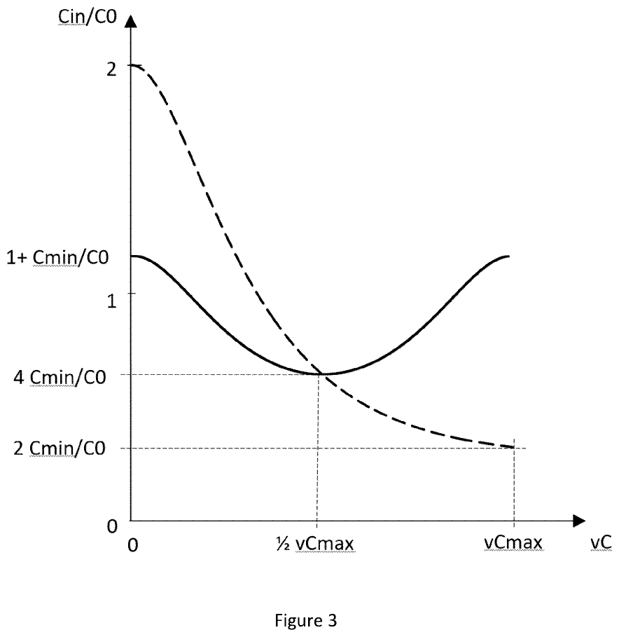

FIG. 3 shows an example of a graph showing the relation between the capacitance value of the combined capacitance of the first ceramic capacitor C1 and the second ceramic capacitor C2 and the fluctuating voltage, e.g. the mains input voltage or rectified mains input voltage. On the X-axis, the fluctuating voltage at the first node N1 is defined from 0 V to a maximum voltage vCmax. On the Y-axis, the relative capacitance of the capacitor is defined. Cin defines the actual capacitance and C0 defines the absolute capacitance of the capacitor. The maximum relative capacitance is 2 since there are two capacitors, where Cin of both capacitors is equal to C0. The minimum capacitance that can be achieved, in the conventional application, is the capacitance value 2Cmin. The relative minimum capacitance is therefore defined as 2Cmin/C0. 2Cmin/C0 is defined at the maximum voltage vCmax. Preferably, the voltage across the capacitor may not exceed this voltage. In the example provided, for simplicity, the first ceramic capacitor C1 and the second ceramic capacitor C2 are assumed to be identical. If the second ceramic capacitor C2 is placed in parallel with the first ceramic capacitor C1 instead of between the first node N1 and the second node N2, then the dashed line shows the relationship as also shown in FIG. 1. The capacitance at the lowest voltage level is twice the capacitance value of one capacitor because the sum of the capacitances of the first ceramic capacitor C1 and the second ceramic capacitor C2 equals twice the capacitance of a single capacitor. An almost exponential decrease of the capacitance occurs based on the increase of the voltage level across the capacitors. At the maximum provided voltage vCmax, the total capacitance is reduced to 2Cmin/C0. However, the solid line shows the total capacitance of the first ceramic capacitor C1 and the second ceramic capacitor C2 according to the present invention. The capacitance at the lowest voltage is lower than in the conventional setup, namely 1+Cmin/C0. The increase of the fluctuating voltage level reduces the capacitance of the first ceramic capacitor C1 almost exponentially and also increase the capacitance of the second ceramic capacitor C2 almost exponentially. At first, the capacitance of the first ceramic capacitor C1 reduces faster than the capacitance of the second ceramic capacitor C2 increases and therefore, the total capacitance reduces at an increasing voltage. This occurs until the voltage level reaches the threshold value of ½ vCmax where the capacitance of the first ceramic capacitor C1 reduces less, while the capacitance of the second ceramic capacitor C2 increases more with the increasing voltage. In this example, the threshold value of ½ vCmax is an example of a threshold level. The skilled person understands that this threshold may be different when a different design is chosen. The total capacitance increases when the voltage increases and is above the voltage threshold vCmax.

In the example provided, at the maximum available voltage vCmax, the total capacitance is 1+Cmin/C0. The total capacitance may also be larger or smaller depending on the design choices of the driver. The minimum capacitance value will always be larger than 2Cmin/C0 and in this example the minimum capacitance value is 4Cmin/C0. In the example provided, the minimum capacitance value is therefore twice as large as in a conventional solution. The minimum capacitance value that is reached with the invention, defined as 4Cmin/C0, is preferably between 50 % and 20 % of the maximum possible voltage defined as C0. More preferably, the minimum capacitance value is between 40 % and 30 %.

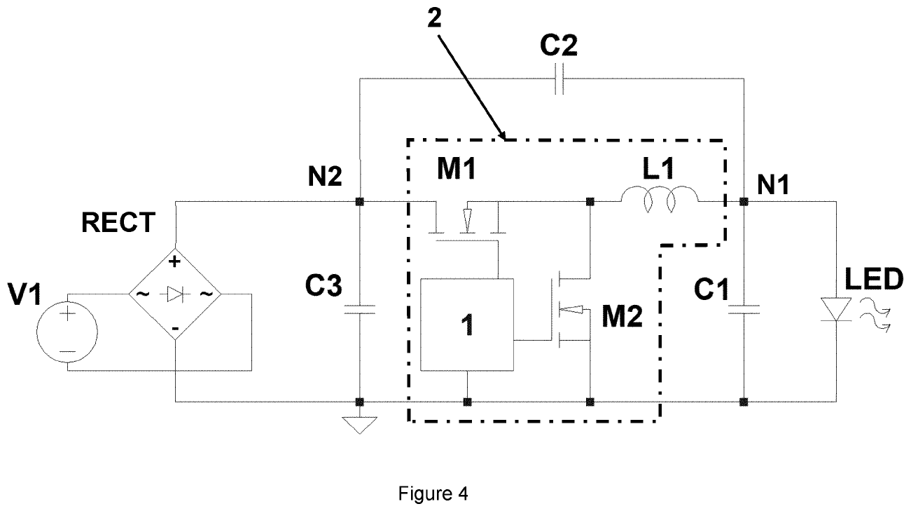

FIG. 4 shows another example of a driver. The driver has a switched mode power converter 2 that is configured as a buck converter. The buck converter has an input that is coupled to the second node N2. The switched mode power converter 2 may have an inductor L1, a switch Mland another switch M2. A controller 1 is used to control the switch M1. The other switch M2 may be a diode. If the other switch M2 is a switch such as a transistor or MOSFET, the other switch may also be controlled by the controller 1. If the other switch M2 is a transistor or a MOSFET, the switched mode power converter 2 may be operated as a synchronous converter. The second ceramic capacitor C2 is coupled to the second node N2. Preferably, the second node N2 is coupled to an optional capacitor C3 that provides a buffer to maintain the voltage at the second node N2 stable. A rectifier circuit RECT may be provided to rectify the input voltage V1. The input voltage may be any type of voltage, preferably a mains voltage as is commonly used such as 230 V at 50 Hz or 120 V at 60 Hz. The first node N1 is coupled to the output of the buck converter. The first ceramic capacitor C1 is coupled to the first node N1. The buck converter provides a fluctuating voltage to the first node N1 and to the load LED, which can be defined as the operating window of the buck converter. The fluctuating voltage does not have to fluctuate in a short moment of time. Throughout time, the voltage may remain constant. A configuration setting may be provided to the controller 1 of the buck converter that allows the voltage provided by the buck converter to vary. The voltage may be increased or decreased within the operating window of the buck converter. This may then be identified as the further fluctuating voltage. The capacitance value has to be guaranteed throughout the entire operating window. Therefore, the second ceramic capacitor C2 is coupled between the first node N1 and the second node N2. The effect as described in the description for FIG. 3 is achieved in a similar way. The effective minimum capacitance value has been increased.

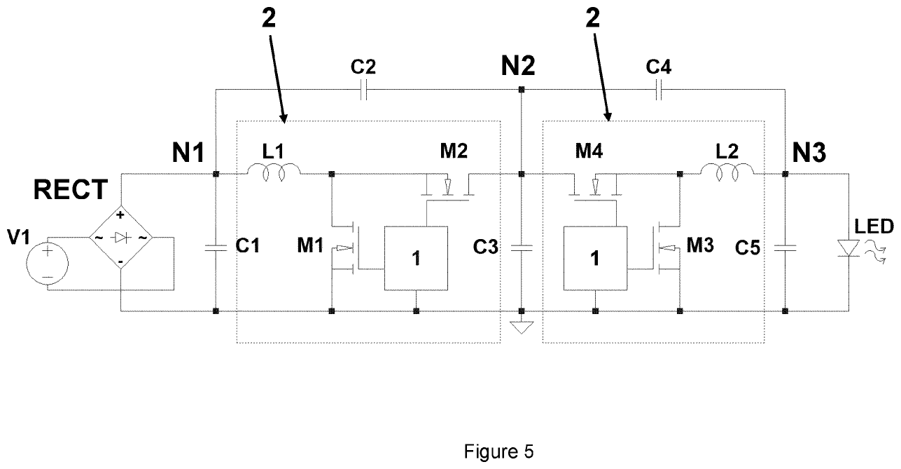

FIG. 5 shows another example of a driver. The driver has a switched mode power converter 2 that is configured as a two-stage converter. The first stage is shown as a boost converter. The boost converter has the same features as the boost converter shown in FIG. 2. A fluctuating voltage such as mains voltage is provided to the input of the driver. The fluctuating voltage is rectified by a rectifier circuit RECT. The rectifier circuit RECT provides a rectified voltage as the fluctuating voltage that is provided to the first node N1. The boost converter provides a stable voltage to the second node N2. The voltage may be buffered by an optional capacitor C3. The stable voltage is provided to the second stage, the buck converter. The buck converter receives the stable voltage at the second node N2. The buck converter provides the further fluctuating voltage to the third node N3 and the load LED. The load LED is also coupled to the third node. Capacitor C5 may be provided for stabilizing the voltage at the output of the buck converter, allowing the buck converter to operate with a voltage window at a stable voltage. The second ceramic capacitor C2 is coupled between the first node N1 and the second node N2. A third capacitor C4 may be placed between the second node N2 and the third node N3. The total minimum capacitance at the input of the boost converter and the total minimal capacitance at the output of the buck converter are then improved. Optionally, only one of the second ceramic capacitor C2 and the third capacitor C4 are used. In one example, the second ceramic capacitor C2 is placed and the third capacitor C4 is not placed.

In the examples provided, the total fluctuation of the capacitance value is now reduced. The maximum capacitance value has been reduced but this is not a problem for the design of a driver. Instead, the absolute minimum value of the capacitance value is a crucial parameter. Since the absolute minimum value of the capacitance value has been increased by the invention, in the example provided it is twice as large, the total design of the driver can be improved.

In the examples provided, the capacitances of the first ceramic capacitor C1 and the second ceramic capacitor C2 are assumed to be substantial identical in value. Additionally, the third capacitor C4, is assumed to be substantial identical in value.

The driver according to any of the examples can be used in many applications, where a regulated power is to be provided to the load. Examples of loads that may be powered by the driver may be a load that can be USB-C powered. Examples of loads that may be powered by the driver can be any of, but not limited to, laptops, mobile phones, lighting loads such as LEDs or laser diodes, monitors or televisions.

Preferably, the switched mode power converter is of the non-isolating type. A buck converter or a boost converter are preferred topologies. Therefore, no isolation transformers are used, making the design of the switched mode power converter simpler.

Preferably, the driver is integrated in a luminaire or a lamp but the driver can also be a standalone driver.

In the examples, the capacitors are shown as a single capacitor. It is to be understood that more capacitors of the same type are used in different configurations to achieve e.g. desired capacitance values or voltage ratings. The capacitors may therefore be comprised of multiple capacitors in series and/or in parallel.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A driver for driving a load, the driver comprising:
a first node adapted to be coupled to a fluctuating voltage;
a second node adapted to be coupled to a stable voltage;
a switched mode power converter configured to convert the fluctuating voltage into the stable voltage or to convert the stable voltage into the fluctuating voltage;
a first ceramic capacitor coupled to the first node; and
a second ceramic capacitor coupled between the first node and the second node, wherein the second ceramic capacitor is arranged to provide a dominant capacitance between the first node and the second node and the first ceramic capacitor is arranged to provide a dominant capacitance to the first node.

2. The driver according to claim 1, wherein a ratio between a capacitance of the first ceramic capacitor and a capacitance of the second ceramic capacitor is based on a ratio between a peak voltage of the fluctuating voltage and an amplitude of the stable voltage.

3. The driver according to claim 1, wherein the switched mode power converter is a boost converter wherein the first node is coupled to an input of the switched mode power converter and wherein the second node is coupled to an output of the switched mode power converter and the load.

4. The driver according to claim 1, wherein the switched mode power converter is a buck converter wherein the second node is coupled to an input of the switched mode power converter and wherein the first node is coupled to an output of the switched mode power converter and the load.

5. The driver according to claim 1, the driver comprising a third node adapted to be coupled to a further fluctuating voltage, wherein the switched mode power converter is a two stage converter, where a first stage is a boost converter and a second stage is a buck converter, wherein an output of the boost converter is coupled to an input of the buck converter, wherein the first node is coupled to an input of the boost converter, the second node is coupled to the output of the boost converter and the input of the buck converter and the third node is coupled to an output of the buck converter and the load, wherein the boost converter is adapted to provide the stable voltage to the second node and the buck converter is adapted to provide the further fluctuating voltage to the third node.

6. The driver according to claim 5, further comprising a third capacitor is coupled between the second node and the third node.

7. The driver according to claim 5, wherein a voltage fluctuation of the fluctuating voltage is larger than a voltage fluctuation of the further fluctuating voltage.

8. The driver according to claim 1, wherein the first ceramic capacitor and the second ceramic capacitor are multilayer ceramic capacitors, MLCC capacitors.

9. The driver according to claim 1, wherein the first ceramic capacitor and the second ceramic capacitor are of the X7R type.

10. The driver according to claim 1, wherein the switched mode power converter is arranged to provide power factor correction.

11. The driver according to claim 1, wherein the switched mode power converter is a synchronous switched mode power converter.

12. The driver according to claim 1, wherein the first ceramic capacitor and the second ceramic capacitor have a substantial identical capacitance.

13. The driver according to claim 1, further comprising a rectifier circuit adapted to rectify an alternating current, AC, voltage into a rectified voltage, wherein the rectified voltage is the fluctuating voltage.

14. A system comprising the driver according to claim 1 and the load.

15. The system according to claim 14, wherein the load is a semiconductor lighting load and wherein the system is a luminaire or a lamp.
